(19) United States
(12) Patent Application Publication
(10) Pub. No.: US 2005/0000752 A1
(43) Pub. Date: Jan. 6, 2005

(54) Lubricating device for lubricating migrating points like those on a conveyor belt

(76) Inventor: Axel Fleige, Ubstadt-Weier (DE)

Correspondence Address: WENDEROTH, LIND & PONACK, L.L.P., 2033 K STREET N. W., SUITE 800, WASHINGTON, DC, 20006-1021, US

(21) Appl. No.: 10/488,557

(22) PCT Filed: May 24, 2003
(86) PCT No.: PCT/EP03/05436

(30) Foreign Application Priority Data
Jul. 17, 2002 (DE) 202 10 758.2

(51) Int. Cl. F16N 7/16

(52) U.S. Cl. 184/15.1

(57) ABSTRACT

The patent application relates to a lubrication device for lubricating traveling lubrication sites (6), such as those on a belt (5) or the like, in particular on a roller or chain belt (5), with a lubricant applicator (2) comprising at least one lubricant outlet (8), and a belt guidance device (3) associated with the lubricant applicator (2), by which the belt (5) or the like is guided during the lubrication process, and is characterized thereby that the lubricant applicator (2) comprising at least one lubricant outlet (8) is developed as a contact lubrication unit and that the lubricant applicator (2) and/or the belt guidance device (3) is comprised of a highly wear-resistant synthetic material or is coated with a highly wear-resistant synthetic material at least on its regions in contact with the belt (5) or the like.

The invention relates to a lubrication device for lubricating traveling lubrication sites, such as those on a belt or the like, in particular on a roller or chain belt, with a lubricant applicator, which comprises at least one lubricant outlet, and a belt guidance device associated with the lubricant applicator, which guides the belt or the like during the lubrication process.

Supplying drive chains or conveyor chains with lubricant is conventionally carried out with two different methods. For one, the continuous application of lubricant onto drive or conveyor chains with a brush is known. Alternatively, lubricants can be applied continuously or clocked by means of lubricant spattering nozzles or drip-feed lubricators. In both cases mainly chain lubricating oil or to a lesser extent also low viscosity grease are used as the lubricant. Due to the higher viscosity, the use of grease as a lubricant is not possible with these two methods.

The lubrication of drive or conveyor chains or the like belts is always carried out in the unloaded empty belt, which means in the region of the belt not transmitting the force. Therefore, in the case of chains or belts under heavy load, with an application of the lubricant with a brush or via lubricant spattering nozzles or drip-feed lubricators, guidance of the belt is required since during start-up operation or with changes of the speed the chain or the belt “whip”. In the case of brush lubrication this leads to strong wear and tear, whereby the service life of the brush is severely limited. In the case of application of lubricant via lubricant spattering nozzles or drip-feed lubricators, the deflections of the belt lead to the fact that the lubrication sites, for example the plate-plate pairings or plate-roller pairings of chains, are missed by the lubricant. This leads to an insufficient supply of the lubrication sites with lubricant.

Furthermore, in an environment highly charged with dirt, the problem is known that dirt collects on the belt wetted with lubricant, which is transferred in undesirable manner onto the material to be conveyed and the chain wheels or the like.

The present invention therefore addresses the problem of providing a lubrication device of the above described type, in which, at a high service life, the reliable application is made possible of any desired lubricant, such as for example lubrication oil, low-viscosity grease or grease.

The invention solves this problem for example thereby that the lubricant applicator comprising at least one lubricant outlet is developed as a contact lubrication unit and that the lubricant applicator and/or the belt guidance device is comprised of a highly wear-resistant synthetic material or at least is coated with a highly wear-resistant synthetic material on its regions coming into contact with the belt or the like.

By means of a contact lubrication unit implemented thus, different lubricants, such as lubrication oils or low-viscosity greases, but also greases with higher viscosity can be applied onto traveling lubrication sites of belts, chains or the like through restricted guidance. Due to the belt guidance device associated with the lubricant applicator, it can be avoided that the lubrication sites of the belt, for example during startup operation or with speed changes of the belt, are moved so far away from the contact lubrication unit that the lubrication process is impaired. Since the lubricant applicator as well as also the belt guidance device are comprised of a highly wear-resistant synthetic material or are coated with it, the entire lubrication device has especially low-wear properties, such that it functions operationally reliably and with long service life.

The lubricant applicator and the belt guidance device preferably define a guidance channel extending in the longitudinal direction of the movement of the lubrication site. Through this guidance channel receiving the belt or the like, the vertical as well as also the horizontal movements of the belt are maintained within defined limits in a direction differing from the lubrication site movement, such that the lubrication application by contact of the belt with the lubricant applicator, comprising the at least one lubricant outlet, is ensured.

If the cross section of the guidance channel is adapted to the geometry of the belt, and the belt is preferably guided in the guidance channel with clearance fit, the belt or the like can simultaneously be cleaned with the lubrication device according to the invention. Dirt adhering on the belt, such as for example glass splinters, chips, etc, are stripped from the belt when it enters into the guidance channel. However, in contrast to a brush lubrication, in which also a certain cleaning of the belt or the like takes place, due to this implementation of the lubrication device according to the invention also firmly adhering dirt is reliably removed from the belt. The lubricant is subsequently applied onto the already cleaned belt or the like, such that the lubrication sites of the belt are wetted directly and not a dirt layer covering the lubrication sites.

The supply of the at least one lubricant outlet with lubricant can be realized constructionally especially simply thereby that in the lubricant applicator channels are provided through which the lubricant is fed by a lubricant pump to the lubricant outlet.

In the lubrication device are preferably provided several lubricant outlets, with the lubricant pump [sic] being allocated to the lubricant outlets via a progressive distributor. Through the utilization of a progressive distributor, an especially exact metering of lubricant to each of the lubricant outlets is possible.

The at least one lubricant outlet preferably terminates, in the moving direction of the belt, in front in the guidance channel, in order for optimum penetration of the lubricant into the belt or the like to take place in the guided region.

With respect to production technique it is further of advantage if the lubricant applicator and/or the belt guidance device is/are each developed as a moulded part.

In further development of the inventive concept, the lubricant applicator and/or the belt guidance device can be supported such that it/they are adjustable by displacement in the horizontal and/or in the vertical direction through fastening elements, such as angles. With these fastening elements the lubrication device can be fastened into any installation, and the displaceability in the horizontal and/or vertical direction makes possible the individual alignment of the lubrication device within the installation.

In the following the invention will be explained with reference to an embodiment example in conjunction with the drawing. Therein depict:

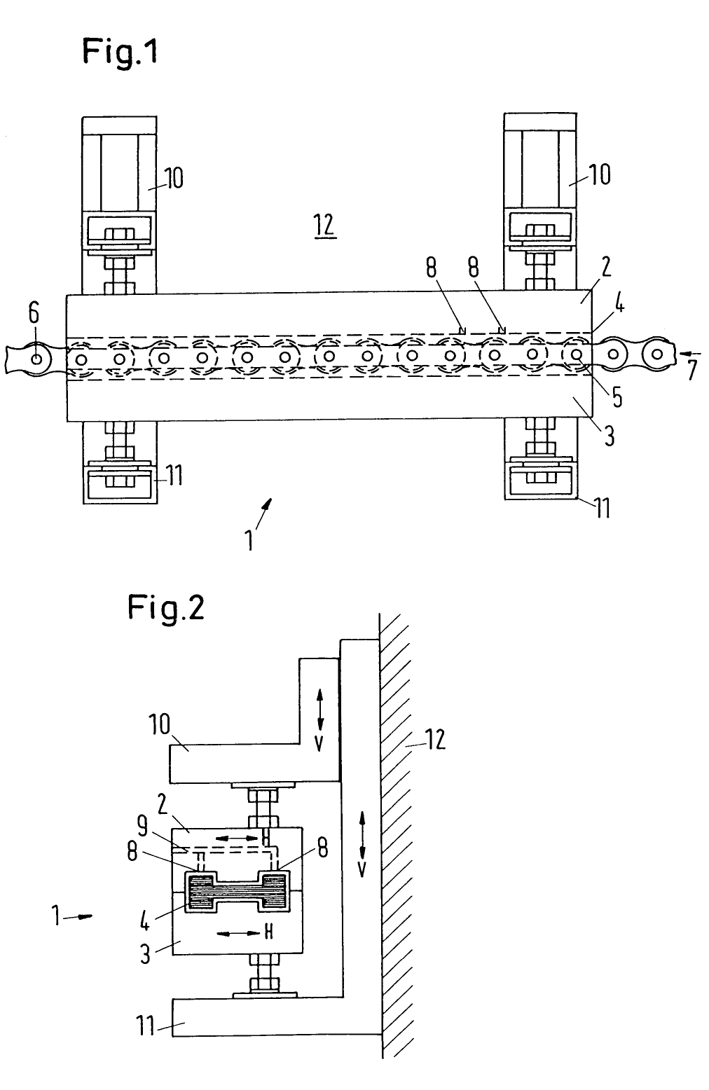

FIG. 1 a schematic side view of the lubrication device according to the invention and

FIG. 2 a schematic view of the lubrication device according to FIG. 1, viewed in the moving direction of the lubrication sites.

A lubrication device 1 depicted in the Figures is substantially comprised of a lubricant applicator 2 and a belt guidance device 3. The lubricant applicator 2 and the belt guidance device 3, which are both developed as moulded parts, encompass a guidance channel 4, which in FIG. 2 has the shape of an H and in which, as indicated in FIG. 1, a belt 5, such as for example a chain, is guided with clearance fit in the sense of a restricted guidance. The cross section depends in each case on the type of chain according to DIN 8187.

The belt 5 has several lubrication sites 6, namely, for example, the plate-plate pairings as well as the plate-roller pairings, which move with the belt 5, as indicated by arrow 7 in FIG. 1. In the lubricant applicator 2 several lubricant outlets 8 are associated with the lubrication sites 6, such that the lubricant applicator 2 is developed as a contact lubrication unit. The lubricant outlets 8 are connected with the channels 9 extending in the lubricant applicator 2, which channels, in turn, are supplied by a lubricant pump with lubricant via a (not shown) progressive distributor.

The lubricant applicator 2 and the belt guidance device 3 can each be secured in position via angles 10, 11 on an installation site denoted in FIG. 2 by reference number 12. The lubricant applicator 2 as well as the belt guidance device 3 are therein supported such that they are adjustable by displacement in the horizontal direction H relative to the angles 10, 11, as is indicated by the double arrows in FIG. 2. Simultaneously, the angles 10 and 11 themselves, as indicated by the double arrows V in FIG. 2, are displaceably securable in position in the vertical direction relative to installation 12.

The lubrication device permits supplying the belt 5 with lubricant and simultaneously cleaning the belt 5. Since the guidance channel 4 is adapted to the geometry of belt 5 and the latter is guided with a clearance fit in the guidance channel 4, dirt adhering on the belt 5 is stripped off through the movement of belt 5 in the direction of arrow 7 on the, in FIG. 1, right side by the lubricant applicator 2 as well as the belt guidance device 3. In this way, with the entrance into the guidance channel 4, the belt 5 is continuously cleaned.

The lubricant outlets 8 are disposed on the, in FIG. 1, right side of the guidance channel 4, located in front in the moving direction of the belt, such that belt 5 after the lubricant application is guided further in the guidance channel 4. In this way the wetting of the lubrication sites 6 with lubricant in the guidance channel 4 is possible, and the unintentional stripping or throwing of lubricant from belt 5 and lubrication sites 6 is avoided, which may occur, for example, during startup operation or with speed changes due to the “whipping” of the belt 5.

Through the horizontally and vertically displaceable support of the lubricant applicator 2 and the belt guidance device 3 in angles 10 and 11, the precise adaptation of the position of the guidance channel 4 within an installation 12 is possible.

The wear and tear of the lubricant applicator 2 as well as of the belt guidance device 3 is minimized thereby that these structural parts are comprised of a highly wear-resistant synthetic material or are at least coated with it. In this way the service lives of all lubrication devices are markedly extended.

### Reference Symbols

Lubrication device
Lubricant applicator
Belt guidance device
Guidance channel
Belt or the like
Lubrication site
Moving direction of belt 5
Lubricant outlet (contact lubrication unit)
Channel
Angle
Angle
Installation
Horizontal displacement
Vertical displacement

1. Lubrication device for lubricating traveling lubrication sites (6), such as those on a belt (5) or the like, in particular on a roller or chain belt (5), with a lubricant applicator (2), which comprises at least one lubricant outlet (8), and a belt guidance device (3) associated with the lubricant applicator (2), by which the belt (5) or the like is guided during the lubrication process, wherein the lubricant applicator (2) comprising at least one lubricant outlet (8) is developed as a contact lubrication unit and that the lubricant applicator (2) and/or the belt guidance device (3) are comprised of a highly wear-resistant synthetic material or are coated with a highly wear-resistant synthetic material at least on their regions coming into contact with the belt (5) or the like.

2. Lubrication device as claimed in claim 1, wherein the lubricant applicator (2) and the belt guidance device (3) define a guidance channel (4) extending in the longitudinal direction of the lubrication site movement.

3. Lubrication device as claimed in claim 2, wherein the cross section of the guidance channel (4) is adapted to the geometry of the belt (5).

4. Lubrication device as claimed in claim 3, wherein the belt (5) is guided in the guidance channel (4) with a clearance fit.

5. Lubrication device as claimed in claim 1, wherein the lubricant applicator (2) channels (9) are provided, through which the lubricant is fed by a lubricant pump to the at least one lubricant outlet (8).

6. Lubrication device as claimed in claim 5, wherein the lubricant is allocated by the lubricant pump to several lubricant outlets (8) via a progressive distributor.

7. Lubrication device as claimed in claim 1, wherein the at least one lubricant outlet (8) terminates, with respect to the moving direction of the belt, in front into the guidance channel (4).

8. Lubrication device as claimed in claim 1, wherein the lubricant applicator (2) and/or the belt guidance device (3) are each developed as moulded parts.

9. Lubrication device as claimed in claim 1, wherein the lubricant applicator (2) and/or the belt guidance device (3) are supported via fastening elements (10, 11), such as angles (10, 11), such that they are settable in position by displacement in the horizontal and/or the vertical direction.
